(19) United States
(12) Patent Application Publication
(10) Pub. No.: US 2008/0173721 A1
(43) Pub. Date: Jul. 24, 2008

(54) Stored value card with fraud protection coded cover

(76) Inventor: Michael H. K. Tang, Monterey Park, CA (US)

Correspondence Address: CHRISTIE, PARKER & HALE, LLP, PO BOX 7068, PASADENA, CA, 91109-7068, US

(21) Appl. No.: 12/011,274

(22) Filed: Jan. 24, 2008

Related U.S. Application Data
(60) Provisional application No. 60/897,422, filed on Jan. 24, 2007.

(51) Int. Cl. G06K 19/06

(52) U.S. Cl. 235/494

(57) ABSTRACT

A secure and confidential card display package and a method of manufacturing the same. The secure and confidential card display package includes a carrier, a stored value card, and a matching code. The card carrier is constructed, for example, of a laminated material. The stored value card is integrally formed with and selectively detachable along a line of weakness from the card carrier, the stored value card having a coded cover adapted to cover a confidential code at a first portion of the stored value card and a corresponding code at a second portion of the stored value card, and the matching code is disposed on the coded cover and adapted to correspond to the corresponding code at the second portion of the stored value card.

### CROSS-REFERENCE TO RELATED APPLICATION

This application claims priority to and the benefit of U.S. Provisional Application No. 60/897,422 filed Jan. 24, 2007, the entire content of which is incorporated herein by reference.

### FIELD OF THE INVENTION

The present invention relates to card display packages and methods of manufacturing the same, and more particularly, to secure and confidential card display covers and methods of manufacturing the same.

### BACKGROUND

Stored value cards distributed by financial institutions and/or telephone companies are typically forwarded to retail merchants for sale to individual purchasers. These stored value cards allow the holder prepaid access to existing phone networks for making phone calls, eliminating the need to carry cash on hand. In addition, they may be used to provide authorization for the rental or purchase of goods and services, or may be used as a gift certificate granting the holder credit for various goods and services.

It has been the practice with prepaid stored value cards that a merchant purchases a stock of cards just as he would any other good, at which time he incurs a charge from the vendor for the value of the stored value card. By displaying these cards for sale in his store, the merchant exposes himself to the loss of the valuable cards through fraud and theft. Furthermore, the merchant must maintain individual inventory stocks for each different value of stored value card he wishes to sell. The merchant's working capital is restricted by the need to maintain these stocks well in advance of when the stored value cards are actually sold as retail items to individual purchasers.

To address these problems, merchants have begun to sell non-activated, or “zero balance” stored value cards which have no intrinsic value until they are activated by the merchant's magnetic, bar code, and/or radio-frequency card reader. It is now a common practice to sell such cards to purchasers with the activation taking place at the merchant counter at the time of sale.

In this manner, the merchant reduces his overhead because the value of the inactivated stored value cards is not payable to the wholesale vendor of the cards until the card itself is actually distributed by the merchant at the point of sale (“POS”).

Upon sale of a stored value card to a purchaser, the merchant encodes the stored value card with a specific balance paid for by the purchaser, and the purchaser may utilize the stored value using a confidential code provided in the card. These cards are often sold mounted in or on some sort of card carrier and/or protective/display package. These cards, however, may still be susceptible to theft and fraud due to tampering. For example, the confidential code may be pre-accessed by a malicious person such that the purchased value of the unsuspected legitimate purchaser may be later stolen.

As such, there is a need to provide a stored value card with a high degree of fraud protection so that it can be readily observed if the card has been tampered with.

### SUMMARY

An aspect of the present invention provides a stored value card with a coded cover (e.g., a coded covering and/or masking element) that can be selectively detachable from the stored value card. The coded cover can be used to cover and/or mask a confidential code to prevent the confidential code from being accessed by a malicious person. In addition, a matching code and/or number is disposed on the coded cover. The matching code and/or number on the coded cover is adapted to match and/or correspond (e.g., to be identical to) a corresponding code and/or number printed at another portion of the stored value card. As such, the stored value card according to the aspect of the present invention is provided a high degree of fraud protection so that it can be readily observed if the card has been tampered with. As an example, if the stored value card has been tempered with and the coded cover has been replaced by a replacement cover that does not have the matching code and/or number, it can be readily observed that stored value card has been tampered with because the replacement cover does not contain a code and/or number that is adapted to match and/or correspond (e.g., to be identical to) the corresponding code and/or number printed at another portion of the stored value card.

In an exemplary embodiment of the present invention, a secure and confidential (or fraud protecting) card display package includes a carrier, a stored value card, and a matching code. The card carrier is constructed, for example, of a laminated material. The stored value card is integrally formed with and selectively detachable along a line of weakness from the card carrier, the stored value card having a coded cover adapted to cover a confidential code at a first portion of the stored value card and a corresponding code at a second portion of the stored value card, and the matching code is disposed on the coded cover and adapted to correspond to the corresponding code at the second portion of the stored value card.

In another exemplary embodiment of the present invention, a method for packaging and fraud protecting a stored value card is provided. The method includes: constructing a card carrier from a card material; forming a stored value card on the card material to be integrally formed with and selectively detachable along a line of weakness from the card carrier and to have a confidential code and a corresponding code; covering the confidential code with a coded cover; and printing a matching code on the coded cover. In this embodiment, the matching code is adapted to correspond to the corresponding code of the stored value card.

### BRIEF DESCRIPTION OF THE DRAWINGS

The accompanying drawings, together with the specification, illustrate exemplary embodiments of the present invention, and, together with the description, serve to explain the principles of the present invention.

FIGS. 1 and 2 show an assembled card display package according to an embodiment of the present invention.

FIGS. 3 and 4 show an assembled card display package according to another embodiment of the present invention.

FIG. 5 shows an assembled card display package according to another embodiment of the present invention.

FIG. 6 is a cross-sectional view of a card carrier and a stored value card according to an embodiment of the present invention.

FIG. 7 is a block diagram of an embodiment of a method used to produce a card carrier and/or a stored value card according to an embodiment of the present invention.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification as they are not essential to a complete understanding of the invention. Like reference numerals designate like elements.

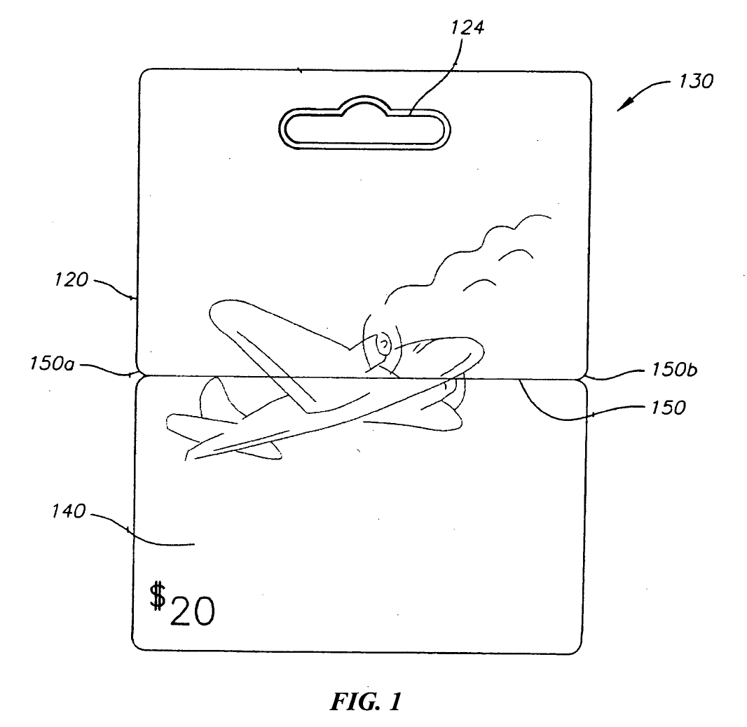

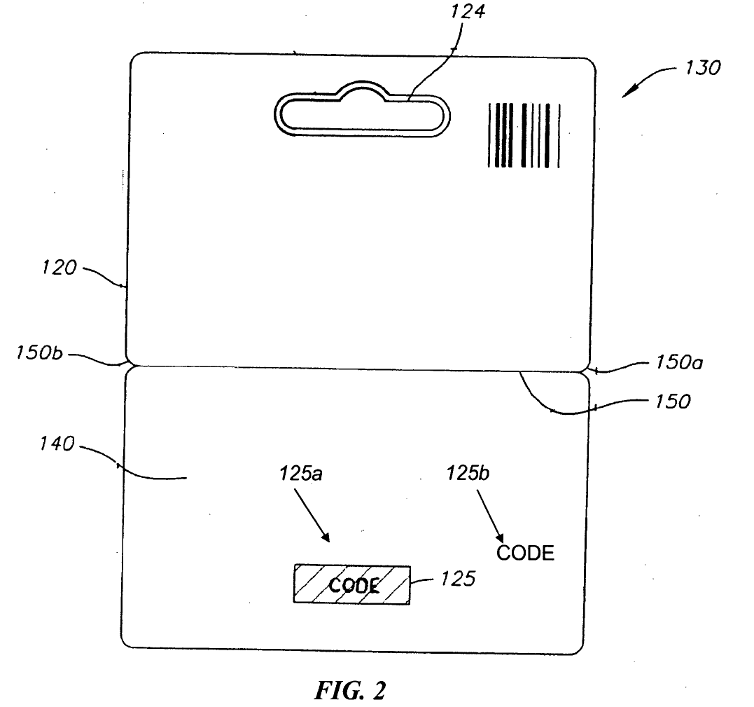

FIGS. 1 and 2 show a planar view of an assembled card display package 130 constructed in accordance with an embodiment of the present invention. The card package 130 includes a card carrier 120 and a stored value card 140, such as a phone card or a debit card. The stored value card 140 is integrally formed with and selectively detachable along a line 150 of weakness and two points 150a and 150b of weakness from the card carrier 120 such that a unitary card package is provided. Here, the card carrier 120 also includes a peg aperture 124 for insertion by a display peg.

The card carrier 120 provides a space for displaying additional information not shown in the card 140. To this end, the card carrier 120 is provided with unique advertising data which may include the establishment that is distributing the stored value card 140. The card carrier 120 may also be provided with non-variable information which may include, for example, instructional information to explain how to use the stored value card 140 and other advertising information related to the establishment that is distributing the stored value card 140.

Similarly, the stored value card 140 is provided with unique data which may include, for example, encoded information in the form of a bar code and/or a magnetic strip. The unique data on the stored value card 140 may correspond to the data on the card carrier 120.

In addition, as shown in FIG. 2, the stored value card 140 includes a coded cover (e.g., a coded covering and/or masking element) 125 that can be selectively detachable from the stored value card 140. The coded cover 125 can be used to cover and/or mask a confidential code to prevent the confidential code from being accessed by a malicious person. In FIG. 2, a matching code (e.g., a number) 125a is disposed on the coded cover 125. The matching code 125a on the coded cover 125 is adapted to match and/or correspond (e.g., to be identical to) a corresponding code (e.g., another number) 125b printed at another portion of the stored value card 140. The matching code 125a and the corresponding code 125b are unique to (or distinct for) each stored value card. As such, the stored value card 140 is provided a high degree of fraud protection so that it can be readily observed if the card has been tampered with.

In more detail, as shown in FIG. 2, the matching code 125a on the coded cover 125 further prevents the stored value card 140 from being tampered with by a malicious person (e.g., to prevent the confidential code from being pre-accessed by the malicious person). The matching code 125a provides the card display package 130 with a high degree of fraud protection. This is because if the stored value card 140 has been tempered with and the coded cover 125 has been replaced by a replacement cover that does not have the matching code 125a, it can be readily observed that stored value card 140 has been tampered with since the replacement cover does not contain a code (e.g., a number) that is adapted to match and/or correspond (e.g., to be identical to) the corresponding code 125b printed at the another portion of the stored value card 140.

In one embodiment, as shown in FIGS. 1 and 2, the stored value card 140 is formed with a size and shape of a conventional credit-type card (and the card carrier 120 is formed with a width that is substantially the same as the stored value card 140).

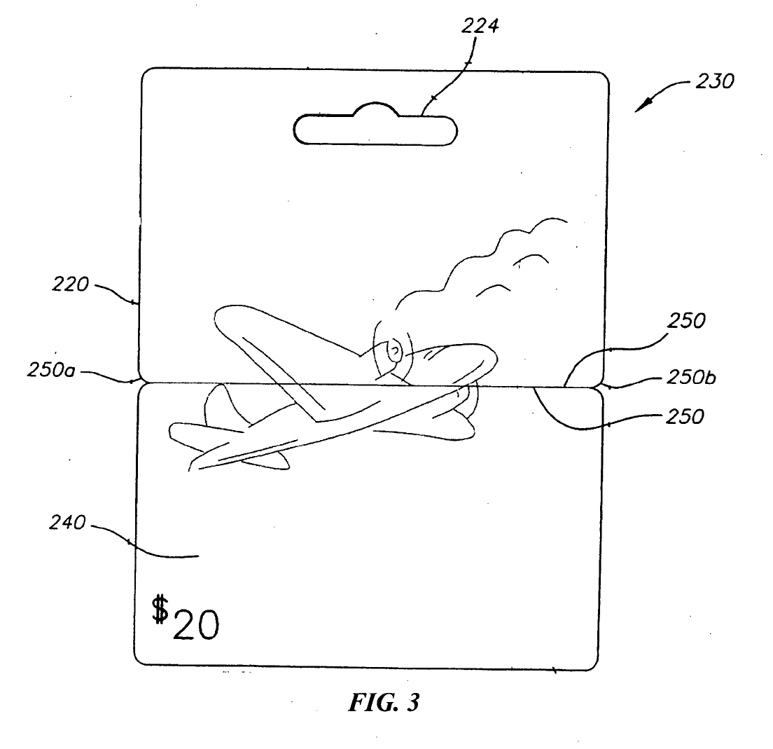

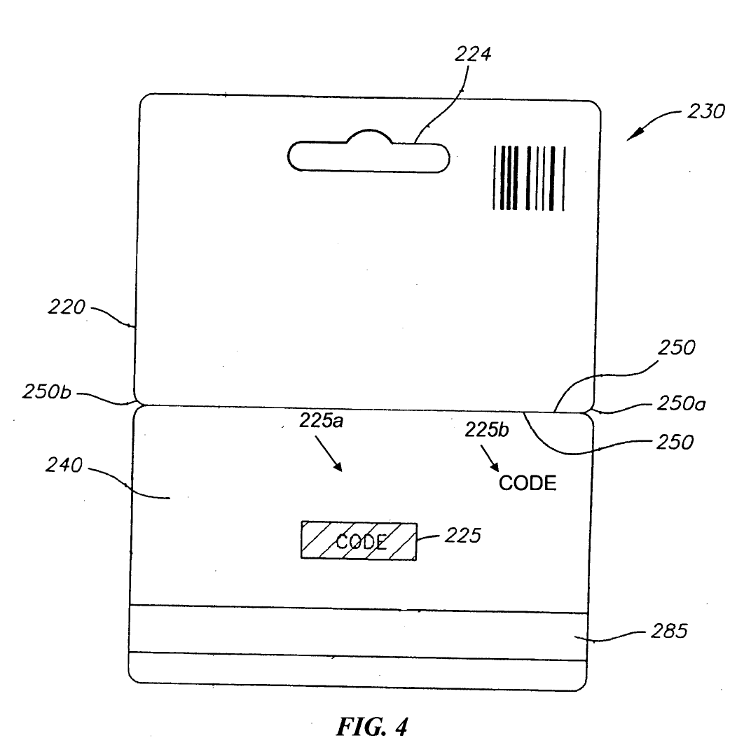

Referring to FIGS. 3 and 4, in an another embodiment of the present invention, an assembled card display package 230 includes a card carrier 220 and a stored value card 240, such as a phone card or a debit card. The stored value card 240 is integrally formed with and selectively detachable along a line 250 of weakness and two points 250a and 250b of weakness from the card carrier 220 such that a unitary card package is provided. Here, the card carrier 220 also includes a peg aperture 224 for insertion by a display peg.

In FIG. 4, the stored value card 240 is shown to include a unique magnetically encodable data strip 285 which may include, for example, encoded information.

In addition, as shown in FIG. 4, the stored value card 240 includes a coded cover (e.g., a coded covering and/or masking element) 225 that can be selectively detachable from the stored value card 240. The coded cover 225 can be used to cover and/or mask a confidential code to prevent the confidential code from being accessed by a malicious person. In FIG. 4, a matching code (e.g., a number) 225a is disposed on the coded cover 225. The matching code 225a on the coded cover 225 is adapted to match and/or correspond (e.g., to be identical to) a corresponding code (e.g., another number) 225b printed at another portion of the stored value card 240. The matching code 125a and the corresponding code 225b are unique to (or distinct for) each stored value card. As such, the stored value card 240 is provided a high degree of fraud protection so that it can be readily observed if the card has been tampered with.

In more detail, as shown in FIG. 4, the matching code 225a on the coded cover 225 further prevents the stored value card 240 from being tampered with by a malicious person (e.g., to prevent the confidential code from being pre-accessed by the malicious person). The matching code 225a provides the card display package 230 with a high degree of fraud protection. This is because if the stored value card 240 has been tempered with and the coded cover 225 has been replaced by a replacement cover that does not have the matching code 225a, it can be readily observed that stored value card 240 has been tampered with since the replacement cover does not contain a code (e.g., a number) that is adapted to match and/or correspond (e.g., to be identical to) the corresponding code 225b printed at the another portion of the stored value card 240.

In one embodiment, as shown in FIGS. 3 and 4, the stored value card 240 is formed with a size and shape of a conventional credit-type card, and the card carrier 220 is formed with a width that is substantially the same as the stored value card 240.

In addition, the line of weakness 250 of FIGS. 3 and 4, and/or the line of weakness 150 of FIGS. 1 and 2 may have seventeen perforated holes per inch. In an alternative embodiment, the line of weakness 250 of FIGS. 3 and 4, and/or the line of weakness 150 of FIGS. 1 and 2 have two perforated holes per inch. In another alternative embodiment, the line of weakness 250 of FIGS. 3 and 4, and/or the line of weakness 150 of FIGS. 1 and 2 have a “perforation” line having a blade-to-tie ratio of 0%; i.e., the central perforation line may be simply a cut line having no perforations therein.

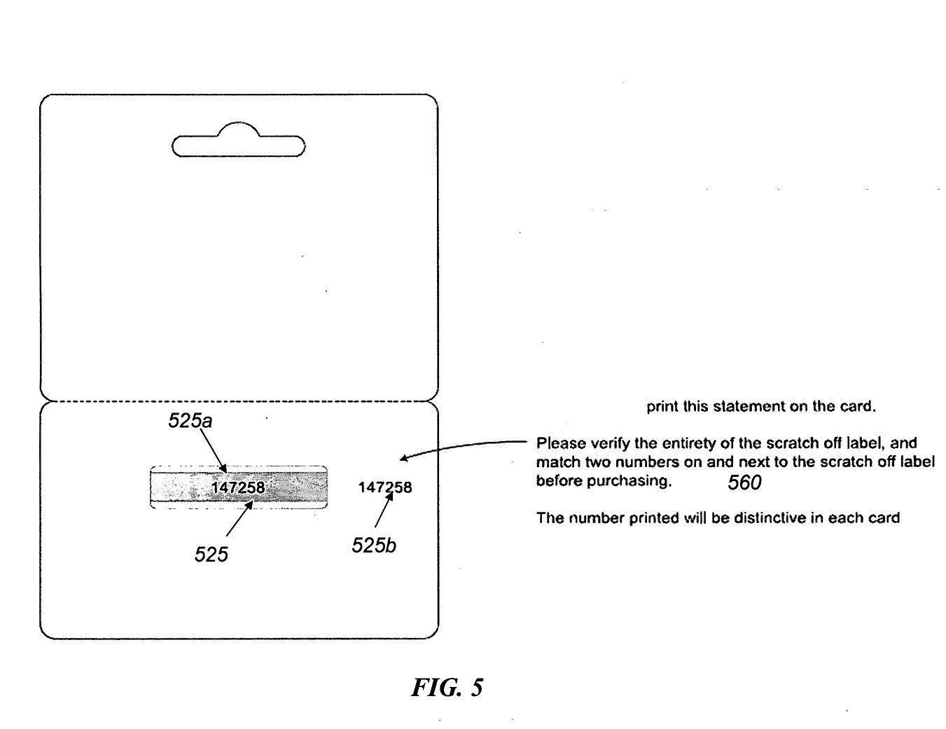

FIG. 5 illustrates an assembled card display package 530 constructed in accordance with an embodiment of the present invention. Similar to the embodiments of FIGS. 1, 2, 3 and/or 4, the card package 530 of FIG. 5 includes a card carrier and a stored value card, such as a phone card or a debit card. The stored value card is integrally formed with and selectively detachable along a line of weakness and two points of weakness from the card carrier such that a unitary card package is provided. Here, the card carrier also includes a peg aperture for insertion by a display peg.

In addition, as shown in FIG. 5, the assembled card display package 530 includes a coded cover (e.g., a coded covering and/or masking element) 525 that can be selectively detachable from the package 530. The coded cover 525 can be used to cover and/or mask a confidential code to prevent the confidential code from being accessed by a malicious person. In FIG. 5, a matching code 525a is disposed on the coded cover 525. The matching code 525a on the coded cover 525 is adapted to match and/or correspond (e.g., to be identical to) a corresponding code 525b printed at another portion of the package 530. Here, for example, the matching code 525a is shown to be the number “147258,” and the corresponding code is also shown to be the number “147258.” However, the present invention is not thereby limited, and the matching code and the corresponding code can be any suitable codes that can be adapted to match and/or correspond with each other.

Also, as shown in FIG. 5, the matching code 525a and the corresponding code 525b are unique to (or distinct for) each stored value card. For example, the number “147258” printed is unique for each card. As such, the assembled card display package 530 is provided a high degree of fraud protection so that it can be readily observed if the card has been tampered with.

In more detail, as shown in FIG. 5, the matching code 525a on the coded cover 525 further prevents the stored value card from being tampered with by a malicious person (e.g., to prevent the confidential code from being pre-accessed by the malicious person). The matching code 525a provides the card display package 530 with a high degree of fraud protection. This is because if the stored value card has been tempered with and the coded cover 525 has been replaced by a replacement cover that does not have the matching code 525a (e.g., the number “147258”), it can be readily observed that stored value card has been tampered with since the replacement cover does not contain a code (e.g., the number “147258”) that is adapted to match and/or correspond (e.g., to be identical to) the corresponding code 525b printed at the another portion of the stored value card.

In one embodiment, as also shown in FIG. 5, the card display package 530 is formed with an additional warning sign (or information) 560 that is printed on the package 530. In FIG. 5, the warning sign 560 is shown to contain a statement for voiding or invalidating the stored value card, such as “Please verify the entirety of the scratch off label, and match two numbers on and next to the scratch off label before purchasing.” This warning sign 560 provides an added security measure to the overall security of the assembled card display package 530.

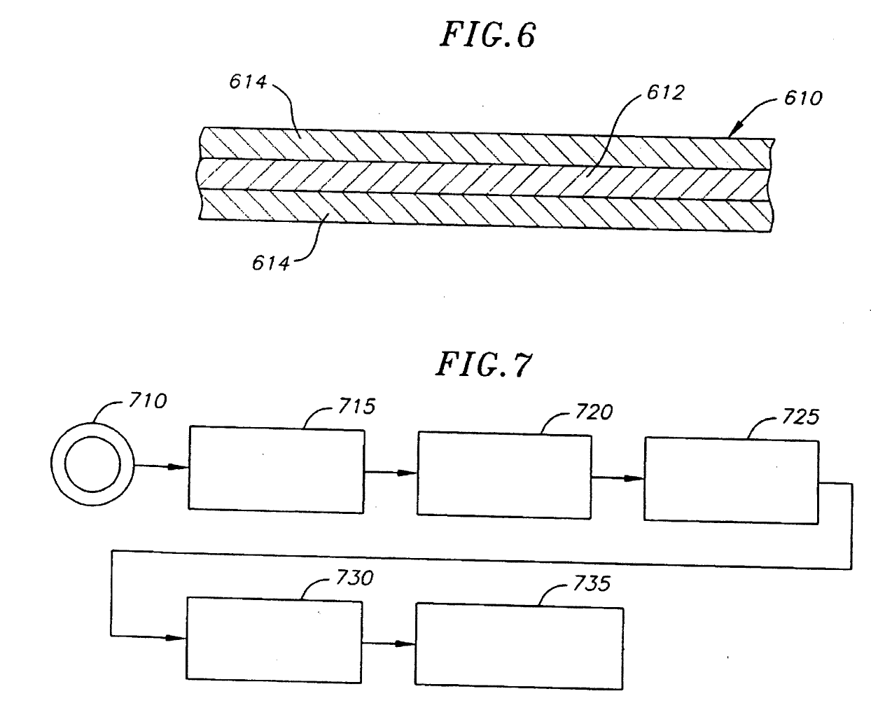

FIG. 6 is a cross-sectional view of an embodiment of a card carrier (e.g., the carrier 120) and/or a stored value card (e.g., the card 140). The embodiment of the card carrier and/or the stored value card is constructed of a card material, such as a sheet of material 612 laminated with two plastic materials 614 to produce a laminated sheet of material 610. The present invention, however, is not thereby limited to the above described laminated sheet of material, and any suitable card material or materials (e.g., card stock, card paper, etc.) can be used to construct the card carrier and/or the stored value card.

FIG. 7 is a block diagram of an embodiment of a method used to produce a card carrier (e.g., the carrier 120) and/or a stored value card (e.g., the card 140). The card carrier and/or the stored value card are formed by first passing a sheet of material 710 through a non-variable printing station 715 where non-variable data of the card carrier and/or the stored value card, such as artwork, instructional information and promotional information is disposed on the sheet of material 612. This data may, in alternative embodiments, be disposed on each side of the sheet of material 612.

The sheet of material 612 is next passed through a variable printing station 720 where the unique data such as a confidential code, a corresponding code (e.g., the code 125b), etc., are disposed on the sheet of material 612. After the unique data has been disposed on the sheet of material 612, it is passed through a laminating station 725 where each side of the sheet of material 612 is laminated with the plastic materials 614 in a manner known to one skilled in the art.

The laminated sheet of material 610 is then passed through a die cut and perforating station 730 where it is cut to the desired size. The laminated sheet of material 610 is perforated and/or weakened at certain line(s) and/or point(s) so as to define the stored value card and the card carrier, as well as other portions of the card display package discussed above.

With the laminated sheet of material 610 correctly sized and shaped, it is passed through a coded cover applicator and a second printing station 735 to apply a coded cover (e.g., the cover 125) to cover the confidential code printed at printing station 720, followed by printing of a matching code (e.g., the code 125a) on the coded cover to complete the card carrier (e.g., the carrier 120) and/or the stored value card (e.g., the card 140).

In view of the above and according to certain embodiments of the present invention, a card display package is provided with an attractive graphical display that allows the entire surface of the actual card to be shown and allows for simple and inexpensive production, while at the same time providing a high degree of fraud protection so that it can be readily observed if the package has been tampered with.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A fraud protecting card display package comprising:
a card carrier;
a stored value card integrally formed with and selectively detachable along a line of weakness from the card carrier, the stored value card having a coded cover adapted to cover a confidential code at a first portion of the stored value card and a corresponding code at a second portion of the stored value card; and
a matching code disposed on the coded cover and adapted to correspond to the corresponding code at the second portion of the stored value card.

2. The fraud protecting card display package of claim 1, wherein the matching code is identical to the corresponding code.

3. The fraud protecting card display package of claim 1, wherein the matching code is a first number and the corresponding code is a second number.

4. The fraud protecting card display package of claim 3, wherein the first number is identical to the second number.

5. The fraud protecting card display package of claim 1, wherein the stored value card and the card carrier are also formed with two points of weakness such that the stored value card is integrally formed with and selectively detachable along the line of weakness and the two points of weakness from the card carrier.

6. The fraud protecting card display package of claim 1, wherein the stored value card is a magnetically encodable card.

7. The fraud protecting card display package of claim 1, wherein the line of weakness is a perforated line.

8. The fraud protecting card display package of claim 1, wherein the line of weakness is a cut line having no perforations therein.

9. The fraud protecting card display package of claim 1, further comprising a warning sign disposed on a third portion of the stored value card to provide an added security measure.

10. The fraud protecting card display package of claim 9, wherein the added security measure includes a warning for invalidating the stored value card when the matching code does not exist.

11. The fraud protecting card display package of claim 9, wherein the added security measure includes a warning for invalidating the stored value card when the matching code does not correspond to the corresponding code.

12. A method for packaging and fraud-protecting a stored value card, the method comprising:
constructing a card carrier from a card material;
forming a stored value card on the card material to be integrally formed with and selectively detachable along a line of weakness from the card carrier and to have a confidential code and a corresponding code;
covering the confidential code with a coded cover; and
printing a matching code on the coded cover,
wherein the matching code is adapted to correspond to the corresponding code of the stored value card.

13. The method of claim 12, wherein the stored value card and the card carrier are also formed with two points of weakness such that the stored value card is integrally formed with and selectively detachable along the line of weakness and the two points of weakness from the card carrier.

14. The method of claim 12, wherein the stored value card is formed to have a magnetically encodable strip.

15. The method of claim 12, wherein the line of weakness is formed as a perforated line.

16. The method of claim 12, wherein the line of weakness is formed as a cut line having no perforations therein.

17. The method of claim 12, wherein the matching code is identical to the corresponding code.

18. The method of claim 12, wherein the matching code is a first number and the corresponding code is a second number.

19. The method of claim 18, wherein the first number is identical to the second number.

20. The method of claim 12, further the forming of stored value card further comprises printing a warning sign on the stored value card to provide an added security measure.

21. The method of claim 20, wherein the added security measure includes a warning for invalidating the stored value card when the matching code does not exist.

22. The method of claim 20, wherein the added security measure includes a warning for invalidating the stored value card when the matching code does not correspond to the corresponding code.
